(19) United States
(12) Patent Application Publication
(10) Pub. No.: US 2011/0199059 A1
(43) Pub. Date: Aug. 18, 2011

(54) CHARGING SYSTEM AND BATTERY PACK

(75) Inventors: Takao Aradachi, Ibaraki (JP); Nobuhiro Takano, Ibaraki (JP)

(73) Assignee: Hitachi Koki Co., Ltd., Tokyo (JP)

(21) Appl. No.: 13/002,242

(22) PCT Filed: Jul. 3, 2009
(86) PCT No.: PCT/JP2009/062564

§ 371 Date: Apr. 21, 2011

(30) Foreign Application Priority Data
Jul. 3, 2008 (JP) 2008-174360
Jul. 3, 2008 (JP) 2008-174409

(51) Int. Cl. H02J 7/00

(52) U.S. Cl. 320/162

(57) ABSTRACT

A charging voltage or an overcharge determination value for determining an overcharge state is set taking into consideration the states of secondary battery cells of a battery pack during charging. Charging of the secondary battery cells is then carried out using charging voltages set taking into consideration the states of the secondary battery cells. It is then determined whether or not the secondary battery cells are in an overcharged state using overcharge determination value is set taking into consideration the states of the secondary battery cells.

### TECHNICAL FIELD

The present invention relates to a charging system and a battery pack, and particularly relates to a charging system for charging a battery pack comprised of a lithium ion secondary battery and a battery pack used in the charging system.

### BACKGROUND ART

In recent years, battery packs comprised of lithium ion secondary batteries are often used as drive sources for cordless power tools. Lithium ion secondary batteries have cells of high nominal voltages and output densities compared to nickel cadmium batteries and nickel hydrogen batteries and can be both small and lightweight. Charging efficiency is also good and charging is also possible in comparatively low temperature environments. It is also possible to obtain a stable voltage at a broad range of temperatures. It is for the above reasons that it is anticipated that battery packs using lithium ion secondary batteries will be adopted as power supplies that can be lightweight, small, and efficient for working with power tools etc.

Charging devices for this type of battery pack are charging devices that typically control charging of battery packs using constant current/fixed voltage control methods. In particular, there are cases where secondary battery cells become damaged when battery packs using lithium ion secondary batteries are overcharged. A charging device therefore carries out charging by first controlling the charging current to be a constant current while monitoring the voltage and current of the secondary battery cells. Next, when the respective voltages of secondary battery cells of a battery pack reach a prescribed voltage (for example, approximately 4.20 volts/cell), charging is carried out with the voltage being controlled to be fixed. The charging device then gradually lowers the charging current. If the charging current then falls below an cut-off charging value, it is determined that charging of the battery pack is complete and charging ends (for example, refer to patent document 1).

[Patent Literature 1] Unexamined Japanese Patent Application KOKAI Publication No. H02-192670.

### SUMMARY OF INVENTION

Lithium ion secondary batteries become overcharged when charging is performed using a charging voltage of a prescribed value or more. When this overcharged state continues, electrolysis of an electrolyte or chemical changes to an electrode material advance and in the worst case a battery may emit fumes or catch fire. Because of this, control is carried out during charging of the battery pack where a voltage of a secondary battery cell is accurately detected and charging is stopped immediately when the voltage of the secondary battery cell is a prescribed value or more.

However, there are variations in the amount of time it takes for a secondary battery cell to become overcharged depending on battery states such as the charging voltage during charging, battery cell temperature, and number of times of charging. For example, when the temperature of the secondary battery cells constituting the battery pack is at a high temperature or a low temperature rather than being within a normal temperature range, there is a tendency for a safety margin for time taken to reach an overcharge state to fall compared to that for a normal state. There are also cases where irregularities occur between states that can be confirmed as overcharging between corresponding secondary battery cells as the result of changing in charging characteristics over time with battery packs constituted from a plurality of secondary battery cells.

It is therefore possible to carry out charging more safely if a charging state of a secondary battery cell can be determined taking into consideration the battery states of the secondary battery cells constituting a battery pack. For example, if it is possible to determine that a battery cell is being overcharged at a voltage lower than a normal voltage (for example, 4.25 volts/cell) when a battery cell is determined to be in a high-temperature state or a low temperature state, it is possible to prevent the secondary battery cell from becoming damaged.

In order to resolve the above situation, it is an object of the present invention to provide a system for charging secondary battery cells taking into consideration the states of the secondary battery cells.

In order to achieve the above object, a charging system of the present invention comprises a battery pack having at least one secondary battery cell, a voltage detection unit that detects voltages of the at least one secondary battery cell, a determination value determining unit that determines an overcharge determination value for determining whether or not a charging state of a secondary battery cell is a state of being overcharged, a determining unit that determines that a secondary battery cell is being overcharged when a voltage of the secondary battery cell is the overcharge determination value or more, and a control unit that stops charging of the battery pack when it is determined that the secondary battery cell is being overcharged, and is characterized in that the determination value determining unit determines the overcharge determination value in accordance with the state of the secondary battery cell.

The determination value determining unit may determine the overcharge determination value based on the number of times of charging of the at least one secondary battery cell.

The overcharge determination value may be set to be smaller than for the case when the number of times of charging is less than or equal to the prescribed number of times when the number of times of charging is greater than the prescribed number of times.

The determination value determining unit may determine the overcharge determination value based on a number of times of charging at a high temperature when the at least one secondary battery cell is at a prescribed temperature or more during charging.

The overcharge determination value may be set to be smaller than the case when the number of times of charging at high temperature is less than or equal to a prescribed number of times, when the number of times of charging at a high temperature is greater than a prescribed number of times.

The determination value determining unit may determine the overcharge determination value based on the number of times of charging at low temperature when the at least one secondary battery cell is at a prescribed temperature or less during charging.

The overcharge determination value may be set to be smaller than the case when the number of times of charging at low temperature is less than or equal to a prescribed number of times, when the number of times of charging at a low temperature is greater than the prescribed number of times.

The determination value determining unit may determine the overcharge determination value based on the number of the at least one secondary battery cell.

The overcharge determination value may be set to be smaller than the case when the number of the at least one secondary battery cell is the prescribed number or less, when the number of the at least one secondary battery cell is greater than a prescribed number.

The charging system of the present invention may further comprise a temperature detection unit that detects the temperature of the at least one secondary battery cell during charging. The determination value determining unit may determine the overcharge determination value based on temperatures detected by the temperature detection unit.

The overcharge determination value may be set to be smaller than when the detected temperature is within the prescribed range when the detected temperature is outside a preset prescribed range.

The charging system of the present invention may further comprise a charging current detection unit that detects charging current of the at least one secondary battery cell during charging. The determination value determining unit may determine the overcharge determination value based on charging current value detected by the charging current detection unit.

The overcharge determination value may be set to be smaller than when the value of the detected charge current is the prescribed value or less, when the value of the detected charge current is larger than the prescribed value.

The charging system of the present invention may further comprise a storage unit that stores the number of times of charging, the number of times of charging at high temperature, and the number of times of charging at low temperature. The determination value determining unit may determine the overcharge determination value based on the number of times of charging, the number of times of charging at high temperature, and the number of times of charging at low temperature stored in the storage unit.

The determination value determining unit may be provided at the battery pack.

The voltage detection unit may detect a voltage of each secondary battery cell, and the determination unit may determine for each secondary battery cell whether or not a charging state of the secondary battery cell is in a state of being overcharged.

The overcharge determination value may be determined based on a secondary battery cell whose temperature rise is largest of the at least one secondary battery cell.

The overcharge determination value may be determined in such a manner that a smallest value is set for a secondary battery cell whose temperature rise is largest of the at least one secondary battery cell.

The secondary battery cells may be lithium ion battery cells.

The charging system of the present invention may further comprise a charging voltage determining unit that determines charging voltages of the at least one secondary battery cell in accordance with the state of the at least one secondary battery cell.

The charging voltage determining unit may determine the charging voltage based on the number of times of charging of the at least one secondary battery cell.

The charging voltage determining unit may determine the charging voltage based on the number of times of charging at a high temperature when the at least one secondary battery cell is at a prescribed temperature or more during charging.

The charging voltage determining unit may determine the charging voltage based on the number of times of charging at a low temperature when the at least one secondary battery cell is at a prescribed temperature or less during charging.

The charging voltage determining unit may determine the charging voltage based on the temperature of the at least one secondary battery cell.

The charging voltage determining unit may determine the charging voltage based on the charging current of the at least one secondary battery cell.

The charging system of the present invention may further comprise a cut-off current determining unit that determines a cut-off current value used to determine whether or not the at least one secondary battery cell is fully charged based on the charging voltage determined by the charging voltage determining unit.

In order to achieve the above object, a battery pack of the present invention comprises a plurality of secondary battery cells, and a storage unit that stores charging history and charging states for the secondary battery cells in a correlated manner.

It is therefore possible to safely execute charging of secondary battery cells taking into consideration the states of the secondary battery cells.

### BRIEF DESCRIPTION OF DRAWINGS

FIG. 1 is a block diagram of a circuit for a charging system of a first embodiment of the present invention;

FIG. 2 is a flowchart illustrating the operation of a charging system;

FIG. 3 is a diagram illustrating a method for setting an overcharge determination value taking into consideration frequency of charging at high-temperature;

FIG. 4 is a diagram illustrating a method for setting an overcharge determination value taking into consideration frequency of charging at low temperature;

FIG. 5 is a diagram illustrating a method for setting an overcharge determination value taking into consideration a number of times of charging;

FIG. 6 is a diagram illustrating a method for setting an overcharge determination value taking into consideration a number of secondary battery cells;

FIG. 7 is a diagram illustrating a method for setting an overcharge determination value taking into consideration battery temperature;

FIG. 8 is a diagram illustrating a method for setting an overcharge determination value taking into consideration charging current;

FIG. 9 is a view illustrating the influence of heat due to the location of arrangement of secondary battery cells within a battery pack;

FIG. 10 is a diagram illustrating a method for setting an overcharge determination value taking into consideration the arrangement of batteries;

FIG. 11 is a flowchart illustrating the operation of a charging system of a second embodiment of the present invention;

FIG. 12 is a diagram illustrating a method for setting an overcharge determination value taking into consideration high-temperature charging frequency;

FIG. 13 is a diagram illustrating a method for setting an overcharge determination value taking into consideration low-temperature charging frequency;

FIG. 14 is a diagram illustrating a method for setting an overcharge determination value taking into consideration a number of times of charging;

FIG. 15 is a diagram illustrating a method for setting an overcharge determination value taking into consideration battery temperature;

FIG. 16 is a diagram illustrating a method for setting an overcharge determination value taking into consideration charging current;

FIG. 17 is a diagram illustrating a method for setting a charging cut-off current; and

FIG. 18 is a charging characteristic view of the charging system.

### DESCRIPTION OF EMBODIMENTS

### First Embodiment

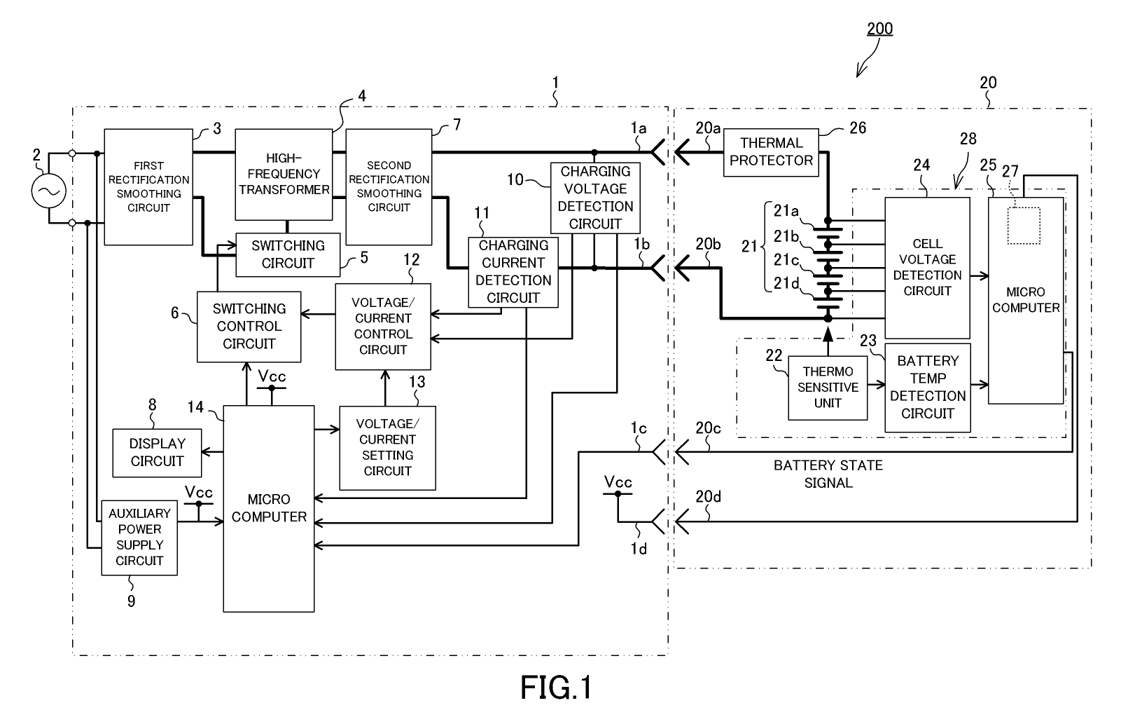

The following is a description with reference to FIGS. 1 to 8 of a first embodiment of the present invention. FIG. 1 is a block diagram showing an outline configuration for a charging system 200 of this embodiment. As shown in FIG. 1, the charging system 200 comprises a battery pack 20, and a charging device 1 that charges the battery pack 20.

The Configuration of the Battery Pack 20

As shown in FIG. 1, the battery pack 20 includes a battery unit 21 comprised of four lithium ion secondary battery cells (referred to simply as secondary battery cells in the following) 21a to 21d connected in series, a battery state detection unit 28 that detects the state of the battery unit 21 and a thermal protector 26.

The battery unit 21 is a 4S1P type unit constituted by secondary battery cells 21a to 21d giving, for example, a nominal voltage of 14.4 V. A primary side and a secondary side of the battery unit 21 are electrically connected to a port 20a and a port 20b respectively of the battery pack 20. Electrical power supplied from the port 20a and the port 20b is then accumulated.

The battery state detection unit 28 is a unit that detects the temperature, the voltage, and the charging current of the secondary battery cells 21a to 21d during charging. The battery state detection unit 28 includes a thermosensitive unit 22, a battery temperature detection circuit 23, a cell voltage detection circuit 24, and a microcomputer 25.

The thermosensitive unit 22 includes thermosensitive elements such as four thermistors, etc. The respective thermosensitive elements are arranged close to the secondary battery cells 21a to 21d constituting the battery unit 21 or are arranged in contact with the secondary battery cells 21a to 21d.

The battery temperature detection circuit 23 is electrically connected to the thermosensitive unit 22. Resistances of thermosensitive elements are then measured and electrical signals corresponding to the resistances are outputted.

The cell voltage detection circuit 24 is electrically connected to the primary sides and the secondary sides of the secondary battery cells 21a to 21d. The cell voltage detection circuit 24 then detects the voltages of the secondary battery cells 21a to 21d and outputs electrical signals corresponding to the detected voltages.

The thermal protector 26 includes a thermosensitive switch employing a bimetal contact point acting according to the temperature of the battery unit 21. This bimetal contact point opens a current path to the battery unit 21 when the temperature of the battery unit 21 reaches a temperature of 80° C. or more from a temperature corresponding to, for example, room temperature. The charging path to the battery unit 21 is then closed when the temperature of the battery unit 21 falls to a prescribed temperature of 80 degrees centigrade or less.

The microcomputer 25 has a memory 27 such as an EEPROM (Electrically Erasable and Programmable Read-Only Memory). This microcomputer 25 detects the respective temperatures and voltages of the secondary battery cells 21a to 21d of the battery unit 21 based on the electrical signals outputted by the battery temperature detection circuit 23 and the electrical signals outputted by the cell voltage detection circuit 24. This temperature information and voltage information is stored in the memory 27 and a value that is the number of times of charging up to this time with 1 added is taken as the new number of times of charging. This number of times of charging is stored in a manner correlated to the temperatures and voltages of the secondary battery cells 21a to 21d of the battery unit 21 detected at the time of charging.

The microcomputer 25 also outputs a battery state signal including temperature information, voltage information, and the number of times of charging. This battery state signal is inputted to a port 1c of the charging device 1 via a port 20c of the battery pack 20. In this embodiment, the microcomputer 25 is applied with a drive voltage Vcc via a port 20d of the battery pack 20.

The Configuration of the Charging Device 1

The charging device 1 is a device that charges the battery pack 20 using electrical power supplied by a commercial power supply 2 of AC100V. The battery pack 20 can be mechanically attached to and detached from the charging device 1. When the battery pack 20 is installed that the charging device 1, the ports 20a to 20d of the battery pack 20 and the ports 1a to 1d of the charging device 1 are electrically connected. Each part constituting the battery pack 20 is then electrically connected to each part constituting the charging device 1.

As shown in FIG. 1, the charging device 1 comprises a first rectification smoothing circuit 3, a high-frequency transformer 4, a switching circuit 5, a switching control circuit 6, a second rectification smoothing circuit 7, a display circuit 8, an auxiliary power supply circuit 9, a charging voltage detection circuit 10, a charging current detection circuit 11, a voltage/current control circuit 12, a voltage/current setting circuit 13, and a microcomputer 14.

Although not shown in the drawings, the first rectification smoothing circuit 3 includes, for example, a full wave rectification circuit including rectification diodes connected together in a bridge and a smoothing capacitor that subjects the mains a.c. power supply 2 to full-wave rectification.

The high-frequency transformer 4 as a primary winding connected to the first rectification smoothing circuit 3 and a secondary winding connected to the second rectification smoothing circuit 7. Electrical power inputted at the primary side is then outputted as a prescribed voltage at the secondary side.

The switching circuit 5 is connected to a primary winding of the high-frequency transformer 4 and includes, for example, a semiconductor switching element such as a MOSFET (Metal-Oxide Semiconductor Field-Effect Transistor) and a PWM control IC (switching control IC) that modulates a pulse width of a drive pulse signal applied to a gate electrode of the semiconductor switching element.

The second rectification smoothing circuit 7 comprises rectification diodes, smoothing capacitors, and discharge resistors etc. Inputted current is then rectified and outputted to the secondary side. Electrical power can then be supplied to the battery pack 20 at a prescribed DC voltage and DC current.

In this embodiment, voltage and current of the output stage of the second rectification smoothing circuit 7 are detected by the charging voltage detection circuit 10 and the charging current detection circuit 11. The detection results are then outputted to the voltage/current control circuit 12 and the microcomputer 14.

In this embodiment, the charging voltage detection circuit 10 is a circuit including a potentiometer such as a potential dividing resister. The charging current detection circuit 11 is a circuit including a current detection resistor connected to a charging line.

The voltage/current control circuit 12 has a comparator for comparing respective values for charging voltages detected by the charging voltage detection circuit 10 and charging currents detected by the charging current detection circuit 11 and respective values for the charging voltages and the charging currents set by the voltage/current setting circuit 13. Differences between the respective charging voltages and charging currents detected by the charging voltage detection circuit 10 and the charging current detection circuit 11 and set charging voltages and set charging currents set by the voltage/current setting circuit 13 are then calculated. A signal corresponding to the results of this calculation is then outputted to the switching control circuit 6.

The switching control circuit 6 supplies a drive signal to the switching control IC constituted by the switching circuit 5 based on a signal from the voltage/current control circuit 12. As a result, pulse width (duty ratio) of a drive for signal applied to the gate electrode of the semiconductor switch is controlled by the switching control IC and the voltage and current outputted from the second rectification smoothing circuit 7 are effectively controlled to be desired values. In this embodiment, the switching control circuit 6 starts supply of the drive signal taking a start signal outputted by the microcomputer 14 as a trigger.

The microcomputer 14 has a CPU, a ROM (Read Only Memory) that stores programs executed by the CPU during charging and data relating to types of batteries constituting the battery pack 20, a RAM (Random Access Memory) utilized as a work region for the CPU and a temporary storage region for data etc. and a timer etc.

This microcomputer 14 detects the battery state of the secondary battery cells 21a to 21d constituting the battery unit 21 of the battery pack 20 based on a battery state signal inputted from the battery pack 20 via the port 1c. Specifically, the microcomputer 14 detects the respective temperatures and voltages of the secondary battery cells 21a to 21d based on the battery state signal. The set values for the charging voltages and the charging currents are then respectively determined based on the detected temperatures and voltages.

When the microcomputer 14 determines the respective set values for the charging voltages and the set value for the charging currents, the set values are outputted to the voltage/current setting circuit 13. The voltage/current setting circuit 13 then sets values for the charging voltages on the charging currents for output to the voltage/current control circuit 12 based on the values set for the charging voltages and the values set for the charging currents.

The microcomputer 14 then determines the charging state of the battery unit 21 based on the output signal of the charging voltage detection circuit 10 and the output signal of the charging current detection circuit 11 and outputs a charging stop signal (overcharging control signal) to the switching control circuit 6 at the time of overcharging. A start instruction signal is then outputted to the switching control circuit 6 at the time of starting charging. The microcomputer 14 outputs a charging stop signal to the switching control circuit 6 when overcharging is detected. In this event, the switching circuit 5 is controlled and the output from the second rectification smoothing circuit 7 is stopped.

In this embodiment, as described in the following, the microcomputer 14 determines whether or not the battery unit 21 is being overcharged based on a battery state detected by the battery state detection unit 28 constituted by the thermosensitive unit 22 housed within the battery pack 20, the battery temperature detection circuit 23, the cell voltage detection circuit 24, and the microcomputer 25 (memory 27). An overcharge determination value (X-Σ, described later) is then determined according to the determination results and it is determined whether to continue or stop charging based on this overcharge determination value.

The display circuit 8 has a display indicator such as an LED for displaying a charging operation state of the charging device 1. This display circuit 8 is driven by a drive signal outputted by the microcomputer 14. In this embodiment, for example, a state before the start of charging is indicated by lighting a red LED using an instruction of the microcomputer 14. The state during charging is then indicated by the lighting of the red LED and a green LED. The state of completion of charging is then displayed by the lighting of the green LED.

The auxiliary power supply circuit 9 includes a voltage transformation transformer for transforming the mains a.c. supply 2 to a low voltage that is a number of tens of volts and a d.c. power supply circuit constituted by regulating diodes and smoothing capacitors etc. and applies a driver voltage Vcc to a PWM control IC of the switching circuit 5 and to the microcomputer 14.

Operation of Charging System 200

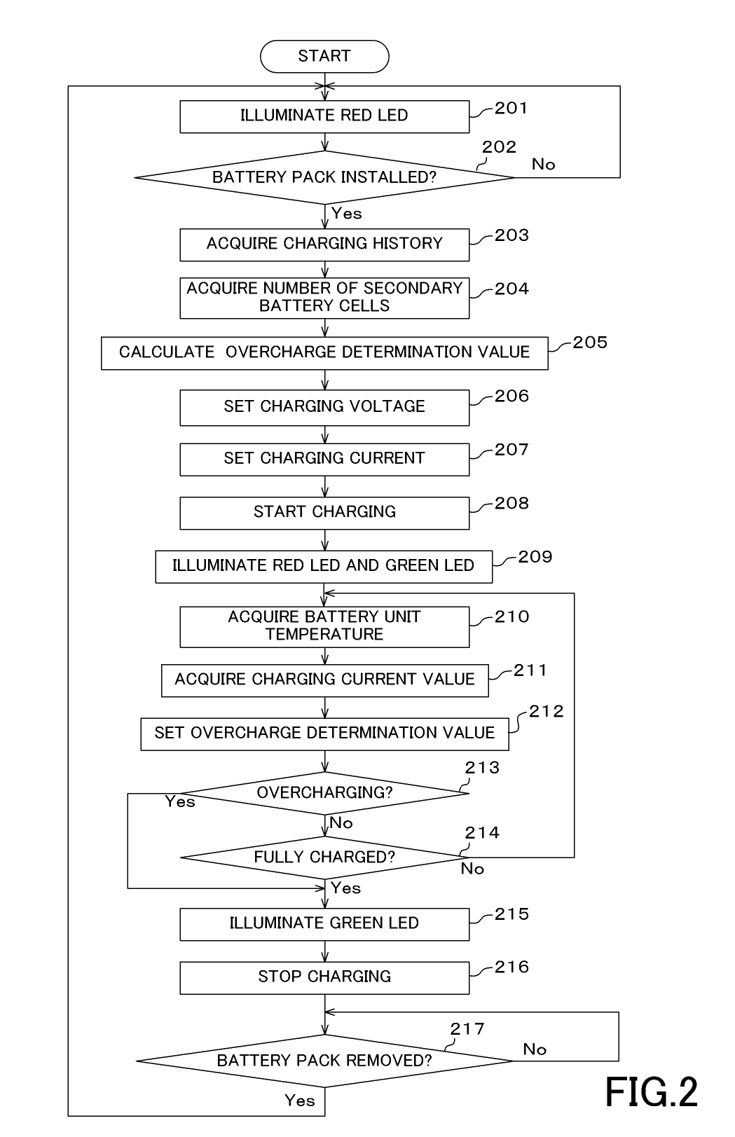

Next, a description is given of the operation of the charging system 200 with reference to the flowchart shown in FIG. 2. When the charging system 200 is connected to the mains a.c. power supply 2, the process shown in FIG. 2 is executed sequentially.

When the charging device 1 is connected to the mains a.c. power supply 2, the microcomputer 14 of the charging device 1 first puts each part in an operable state and the microcomputer 14 is put in an initial state. At the battery pack 20, the microcomputer 25 initially puts each part in an operable state. The microcomputer 14 then sequentially executes the processing shown in FIG. 2.

In a first step 201, the microcomputer 14 sets the red LED of the display circuit 8 on and indicates that it is before the start of charging.

Next, in step 202, the microcomputer 14 determines whether or not the battery pack 20 is installed in the charging device 1. In this embodiment, when the battery pack 20 is installed in the charging device 1, the microcomputer 25 of the battery pack 20 is energized. The microcomputer 25 then notifies the microcomputer 14 of information to the effect that the battery pack 20 is installed via the port 20c. When the microcomputer 14 is notified by the microcomputer 25 of this information, the microcomputer 14 determines that the battery pack 20 is installed in the charging device 1. The method of determining whether or not the battery pack 20 is installed described above is given merely as an example and is by no means limiting.

Next, in step 203, the microcomputer 14 acquires charging history information (battery state information) for up until now for the battery pack 20 from the microcomputer 25 of the battery pack 20. History information (battery state signal Cc) for each charging of the secondary battery cells 21a to 21d is stored in the memory 27 built into the microcomputer 25 of the battery pack 20. For example, history such as a number of times of charging at high temperature where the battery pack 20 is charged at a temperature greater than or equal to a prescribed battery temperature, a number of times of charging at low temperature were charging takes place at a temperature smaller than or equal to a prescribed battery temperature, and the number of times of charging up to this time is stored as charging history for the battery pack 20.

Next, in step 204, the microcomputer 14 acquires information relating to the number of cells for the secondary battery cells 21a to 21d built into the battery pack 20 from the microcomputer 25 of the battery pack 20.

Next, in step 205, the microcomputer 14 calculates an overcharge determination value for determining whether or not the secondary battery cells 21a to 21d constituting the battery pack 20 are in an overcharged state based on information acquired from the microcomputer 25 of the battery pack 20 in step 203 and step 204.

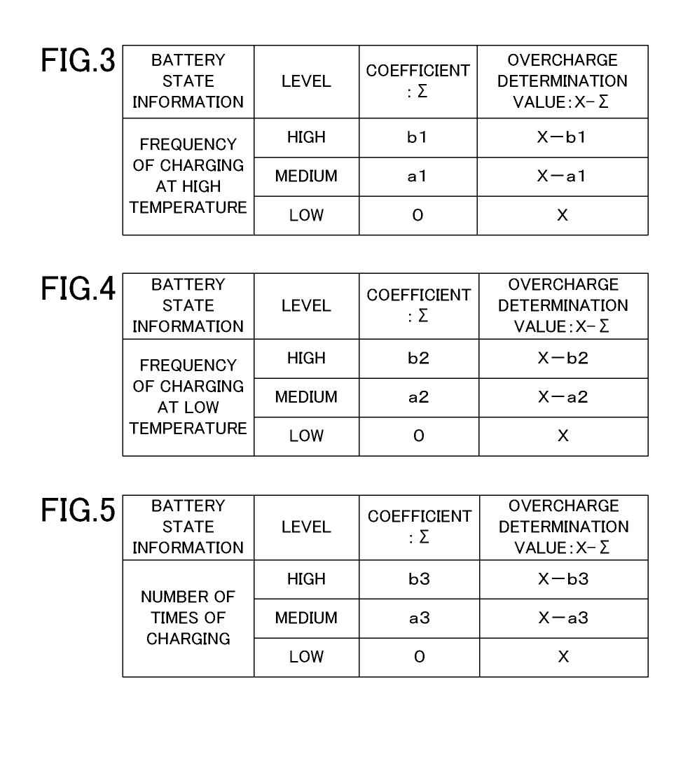

A method for calculating the overcharge determination value is now described in the following with reference to FIGS. 3 to 6. The microcomputer 14 first determines the level of frequency at which the battery pack 20 is charged at a high temperature. The level is determined as any of a high-level, a medium level, and a low-level. The determination is made based on the information acquired from the microcomputer 25 of the battery pack 20 in step 203. As can be understood with reference to FIG. 3, the microcomputer 14, for example, determines a high-level when a frequency of charging at high temperature is a first prescribed number n1 or more, determines a medium level when less than the first prescribed number n1 but greater than or equal to a second prescribed number n2 smaller than the first prescribed number n1, and determines a low-level when lower than the second prescribed number n2. The three classifications for the level are determined empirically from the point of view of the charging lifespan of the secondary battery cells 21a to 21d and are stored in the memory of the microcomputer 14.

A coefficient Σ(V/number of cells) corresponding to the level classifications and standards setting values X (V/number of cells) taken as overcharge determination values are stored in the memory of the microcomputer 14. As can be understood with reference to FIG. 3, the microcomputer 14 sets a value that is just a prescribed value b1 (for example, 0.02V/cell) from the reference set value X (for example, 4.25V/cell) i.e. a value X-b1 (V/number of cells) as the overcharge determination value (X-Σ) when the frequency of charging at a high temperature is determined to be at the high-level.

The microcomputer 14 also sets a value that is smaller than the reference set value X by a prescribed value a1 (b1>a1) (for example, 0.01V/cell) i.e. a value X-a1 (V/number of cells) as the overcharge determination value (X-Σ) when the frequency of high-temperature charging is determined to be a medium level.

The microcomputer 14 sets the reference set value X to the overcharge determination value (X-Σ) when the frequency of high-temperature charging is determined to be a low level.

Similarly, the microcomputer 14 determine the level of frequency at which the battery pack 20 is charged at a low temperature. The level is determined as any of a high-level, a medium level, and a low-level. The determination is made based on the information acquired from the microcomputer 25 of the battery pack 20. As can be understood by referring to FIG. 4, the microcomputer 14 determines that the frequency of charging at a low temperature is a high-level when the frequency of charging at a low temperature of the battery pack 20 is the first prescribed number of times r1 or more. The microcomputer 14 then sets a value that is smaller than the reference set value X (V/number of cells) by just the prescribed value b2, i.e. a value X-b2 (V/number of cells) as the overcharge determination value (X-Σ). The microcomputer 14 determines the frequency of low temperature charging to be the medium level when the frequency of low temperature charging is less than the first prescribed number of times r1 but greater than or equal to a second prescribed number of times r2 that is smaller than the first prescribed number of times r1. The microcomputer 14 then sets a value that is smaller than the reference set value X by just a prescribed value a2 (b2>a2) i.e. a value X-a2 (V/number of cells) to be the overcharge determination value (X-Σ). The microcomputer 14 sets the reference set value X to be the overcharge determination value (X-Σ) when the frequency of low temperature charging is determined to be a low-level that is less than the second prescribed a number of times r2.

Similarly, the microcomputer 14 determines the level of the number of times the battery pack 20 is charged acquired from the microcomputer 25. As can be understood by referring to FIG. 5, the microcomputer 14 sets a value that is smaller by a prescribed value b3 than the reference set value X i.e. a value X-b3 (V/number of cells) as the overcharge determination value (X-Σ) when it is determined that the total number of times of charging of the battery pack 20 is larger than a prescribed value. The microcomputer 14 also sets a value that is smaller by a prescribed value a3 (b3>a3) than the reference set value X i.e. a value X-a3 (V/number of cells) as the overcharge determination value when the total number of times of charging is determined to be substantially the same as a prescribed value. The microcomputer 14 sets the reference set value X to the overcharge determination value (X-Σ) when the total number of times of charging is determined to be smaller than a prescribed value.

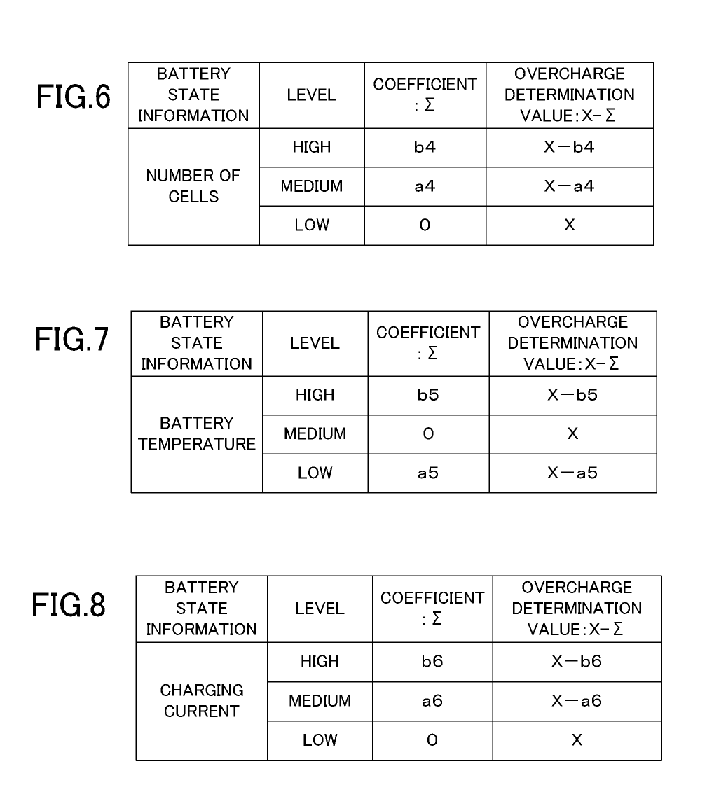

The microcomputer 14 sets the overcharge determination value based on the number of cells for the battery pack 20 acquired from the microcomputer 25. Referring to FIG. 6, the microcomputer 14 sets a value that is smaller by just b4 than a reference set value X i.e. a value X-b4 (V/number of cells) as the overcharge determination value (X-Σ) when the number of secondary battery cells 21a to 21d constituting the battery pack 20 acquired in step 204 is the first prescribed number of cells m1 or more. A value that is smaller by just a4 (b4>a4) than the reference set value X, i.e. a value X-a4 (V/number of cells) is set as the overcharge determination value (X-Σ) when the number of secondary battery cells 21a to 21d is equal to or greater than the second prescribed value m2 smaller than the first prescribed value m1, and less than the first prescribed value m1. When the number of secondary battery cells 21a to 21d is less than the second prescribed value m2, the reference set value X is set as the overcharge determination value.

The microcomputer 14 then determines upon the overcharge determination value (X-Σ) as the respective overcharge determination values for the secondary battery cells 21a to 21d. In this embodiment, the microcomputer 14 converts overcharge determination values for the secondary battery cells 21a to 21d to the overcharge determination values for the battery unit 21 constituted by the plurality of secondary battery cells 21a to 21d. As a result, the microcomputer 14 can detect the overcharge state of the battery unit 21 by directly comparing the overcharge determination value of the battery unit 21 and the voltage detected by the charging voltage detection circuit 10.

In the next step 206, the microcomputer 14 sets a charging voltage corresponding to the number of secondary battery cells 21a to 21d acquired in step 204. The microcomputer 14 then notifies the voltage/current setting circuit 13 of the set charge voltage.

Next, in step 207, the microcomputer 14 sets the charging current according to the temperature of the battery unit 21. The temperature of the battery unit 21 is then detected by the battery temperature detection circuit 23 via the thermosensitive unit 22 and can be outputted to the microcomputer 25. The microcomputer 14 then acquires the temperature of the battery unit 21 from the microcomputer 25. When the temperature of the battery pack 20 is within a normal temperature range (within a range of prescribed value T1 to T2) (T1<T2), the voltage/current setting circuit 13 is notified of a setting value for setting the charging current to I1.

When the temperature of the battery unit 21 is a low temperature lower than the lower limit T1 for the normal temperature, the microcomputer 14 notifies the voltage/current setting circuit 13 of a setting value for setting the charging current to I3 (I3<I1). When the battery temperature is a high temperature higher than an upper limit value (T2) for the normal temperature, the microcomputer 14 notifies the voltage/current setting circuit 13 of a setting values for setting the charging current to I2 (I3<I2<I1).

Next, in step 208, the microcomputer 14 outputs a charge start signal for starting charging to the switching control circuit 6. The switching circuit 5 therefore starts to operate and charging of the battery pack 20 commences.

Next, in step 209, at the same time as the start of charging, the microcomputer 14 lights up the red LED and the green LED of the display circuit 8. It can therefore be displayed that the battery pack 20 is being charged.

Next, in step 210, the microcomputer 14 instructs the detection of the temperature of the battery unit 21 to the microcomputer 25. The microcomputer 14 is therefore notified of temperature information of the battery unit 21 that is being monitored via the battery temperature detection circuit 23 by the microcomputer 25.

Next, in step 211, the microcomputer 14 acquires information relating to the charging current values for the battery unit 21 via the charging current detection circuit 11.

Next, in step 212, the microcomputer 14 calculates overcharge determination values based on the temperature of the battery unit 21 and the charging current values are acquired in step 210 and step 211.

In the following, the method of calculating the overcharge determination value in step 212 is described with reference to FIGS. 7 and 8. The microcomputer 14 first determine the temperature level of the battery unit 21. The level is determined as any of a high-level, a medium level, and a low level. As can be understood with reference to FIG. 7, this level is one of three types of high, medium, and low. When, for example, the temperature of the battery unit 21 is the first prescribed value t1 or more, the microcomputer 14 determines that the level is a high-level. When the temperature is greater than or equal to a second temperature t2 that is smaller than the first prescribed temperature t1 and is less than the first prescribed temperature t1, a medium level is determined. When the temperature is less than the second temperature t2, a low-level is determined.

Next, as can be understood with reference to FIG. 7, the microcomputer 14 sets a value that is smaller than the reference set value X by just a prescribed value b5, i.e. a value X-b5 (V/number of cells) to the overcharge determination value (X-Σ) when the temperature level of the battery unit 21 is determined to be a high-level. When it is determined that the temperature level of the battery unit 21 is a low-level, the microcomputer 14 sets a value that is smaller than the reference set value X by just a prescribed value a5 (b5>a5), i.e. sets a value X-a5 (V/number of cells) as the overcharge determination value (X-Σ). When it is determined that the temperature level of the battery unit 21 is a medium level, the microcomputer 14 sets the reference set value X as the overcharge determination value (X-Σ).

Similarly, as can be understood with reference to FIG. 8, the microcomputer 14 determines the level of the acquired charging current value. The level is determined as any of a high-level, a medium level, and a low-level. As can be understood with reference to FIG. 8, when the level of the charging current value is determined to be a high-level, the microcomputer 14 sets a value that is smaller than the reference set value X by just a prescribed value b6, i.e. a value X-b6 (V/number of cells) as the overcharge determination value (X-Σ). When the level of the charging current value is determined to be a medium level, the microcomputer 14 sets a value that is smaller than the reference set value X by a prescribed value a6 (b6>a6), i.e. sets a value X-a6 (V/number of cells) as the overcharge determination value (X-Σ). When the level of the charging current value is determined to be a low-level, the microcomputer 14 sets the reference set value X as the overcharge determination value (X-Σ).

Next, in step 213, the microcomputer 14 determines whether or not the voltages of the battery unit 21 detected by the charging voltage detection circuit 10 of the charging device 1 and the cell voltage detection circuit 24 of the battery pack 20 are equal to or greater than the overcharge determination values set in step 205 and step 212. When the charging voltage or the voltage of the battery unit 21 is the overcharge determination value or more, the determination of step 213 is affirmative, and step 215 is proceeded to. On the other hand, when the detected charging voltage or the voltage of the battery unit 21 is less than or equal to the set overcharge determination value, the microcomputer 14 determines that the battery pack 20 is not being overcharged and step 214 is proceeded to.

In step 214, the microcomputer 14 determines whether or not the battery unit 21 of the battery pack 20 is fully charged. The determination of full charging can adopt a method of determination that is typically carried out for lithium ion secondary batteries. For example, when charging is carried out using a constant current/fixed voltage charging method, charging is first carried out while maintaining a state where the charging current is fixed. When the secondary battery cells 21a to 21d of the battery pack 20 then reach respective prescribed voltages, charging can then be carried out while maintaining a fixed charging voltage. When the respective secondary battery cells 21a to 21d then become fully charged, the charging current is lowered to the cut-off charging current value. It is then possible to determine whether or not the secondary battery cells 21a to 21d of the battery unit 21 are in fully charged states by determining whether or not the value of the charging current is equal to the value of the cut-off charging current.

When the determination in step 214 is negative, the microcomputer 14 returns to step 210 and executes the processing from step 210 to step 214 until the determination of step 214 is affirmative. There are on the other hand, when the determination of step 214 is affirmative, the next step 215 is proceeded to.

In the next step 215, the microcomputer 14 gives notification that charging is complete by causing a green light to be displayed at the display circuit 8.

Next, in step 216, the microcomputer 14 controls the operation of the switching circuit 5 so as to stop charging by outputting a charging stop signal to the switching control circuit 6.

Next, in step 217, the microcomputer 14 determines whether or not the battery pack 20 has been removed from the charging device 1. When the battery pack 20 has been removed, the determination here is affirmative and step 201 is returned to. The microcomputer 14 then repeatedly executes the processing from step 201 to step 217.

As shown in the above description, in this embodiment, overcharge determination values can be set in order to determine the presence or absence of an overcharge state taking into consideration the states of the secondary battery cells of the battery pack during charging. It is then possible to determine whether or not the secondary battery cells are in an overcharged state using overcharge determination values set taking into consideration the states of the secondary battery cells. It is therefore possible to accurately detect overcharging states that fluctuate due to the number of times of use of the battery packs and the temperature etc. It is then possible to effectively execute charging of the battery packs in a safe manner.

In particular, there are cases where the charge time vs charge voltage characteristics cause variations to occur between a plurality of battery cells within a battery pack. If the overcharge determination value is then set according to the state of the batteries, it is possible to prevent excessive overcharging and a safe charging system can be provided.

In the above embodiment, overcharge determination values are set based on the temperature of the battery unit 21 detected by the battery temperature detection circuit 23. However, the present invention is by no means limited in this respect, and it is also possible to set to overcharge determination values every secondary battery cell. For example, it is also possible to set the overcharge determination value based on the temperature of secondary battery cells of the secondary battery cells for which the likelihood of an increase in temperature during charging is high compared to other secondary battery cells.

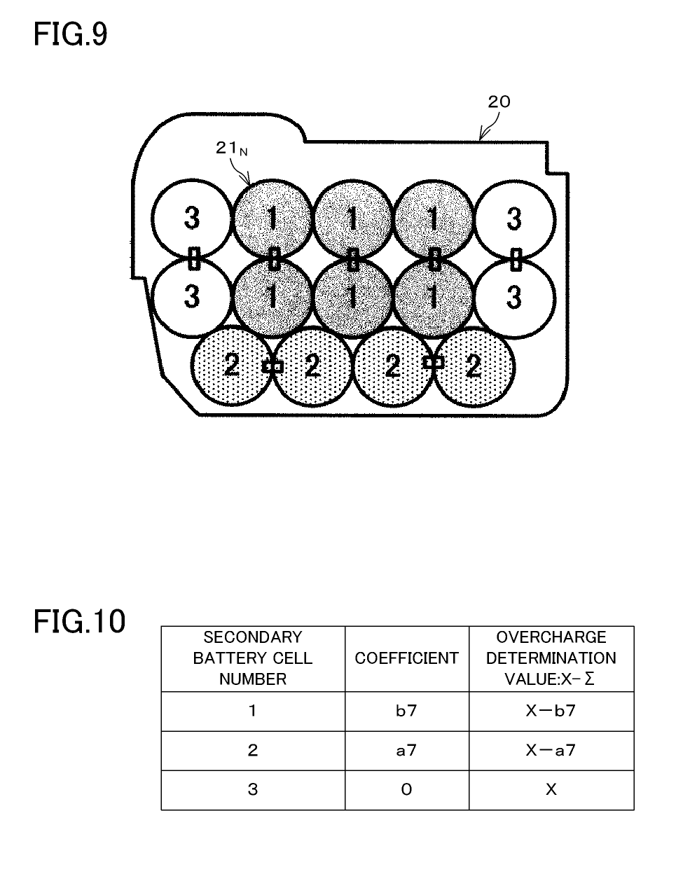

FIGS. 9 and 10 are views illustrating an example of changing overcharge determination values according to the arrangement of a plurality of secondary battery cells of the battery unit 21.

FIG. 9 is a view showing an arrangement for a plurality of secondary battery cells 21_{N} arranged within the battery pack 20. Pairs of secondary battery cells are mutually connected together in parallel within the battery pack 20. The seven pairs of secondary battery cells are then connected together in series arranged at the positions of seven blocks so as to give the battery pack 20 with a nominal output voltage of 25.2 V. In this event, it is preferable to monitor the states of the battery voltages every seven pairs of cell blocks.

The location for installing the secondary battery cells 21_{N} is divided into three. As shown in FIG. 9, number 1 is assigned to the secondary battery cells 21_{N} arranged at a central part within the battery pack 20. Number 2 is assigned to secondary battery cells 21_{N} arranged at the bottom part of the battery pack 20. Number 3 is assigned to secondary battery cells 21_{N} arranged to the left and right of the battery pack 20.

The three pairs of secondary battery cells 21_{N} assigned with the number 1 are surrounded by the secondary battery cells 21_{N} assigned with the number 2 or the number 3. This means that the three pairs of secondary battery cells 21_{N} assigned with the number 1 are easily influenced by heat from the secondary battery cells 21_{N} assigned with the number 2 or the number 3. The three pairs of secondary battery cells 21_{N} assigned with the number 1 also have a dissipation efficiency with respect to heat generated by themselves that is low compared to other secondary battery cells 21_{N}. The progress of deterioration of the secondary battery cells 21_{N} assigned with the number 1 is also comparatively fast compared to other secondary battery cells 21_{N}.

The secondary battery cells 21_{N} assigned with the number 2 are next easily influenced by heat and the secondary battery cells 21_{N} assigned with the number 1. The secondary battery cells 21_{N} assigned with the number 3 are least influenced by heat from other secondary battery cells 21_{N}.

This means that in step 205 and step 212 of the flowchart for control shown in FIG. 2, it is also effective for the overcharge determination values for determining the presence or absence of overcharging to be set according to the arrangement of the secondary battery cells.

As can be understood with reference to FIG. 10, the overcharge determination values X-Σ (V/number of cells) for the secondary battery cells 21_{N} assigned with the number 1 assigns a value that is smaller than the reference value X by just a prescribed value b7 i.e. a value X-b7 (V/number of cells) as the overcharge determination value (X-Σ). The overcharge determination value X-Σ (V/number of cells) for the secondary battery cells 21_{N} assigned with the number 2 sets a value that is smaller by just a prescribed value a7 (b7>a7) than the reference set value X i.e. a value X-a7 (V/number of cells) as the overcharge determination value (X-Σ). The overcharge determination value for the secondary battery cells 21_{N} assigned with the number 3 is then taken to be the reference set value X.

According to this, the overcharge determination value can be set according to the location of arrangement of the secondary battery cell 21_{N}. It is then possible to determine whether or not the secondary battery cell 21_{N} is in an overcharge state using this overcharge determination value. It is therefore possible to accurately detect a charging state that fluctuates according to the influence of heat specific to the secondary battery cells 21_{N} and it is therefore possible to effectively charge the battery pack in a safe manner.

### MODIFIED EXAMPLE

In the embodiment described above, state information Cc (for example, levels for the frequency of high-temperature charging as shown in FIG. 3) for battery states detected by the battery state detection unit 28 is notified to the microcomputer 14 of the charging device 1 from the microcomputer 25 of the battery pack 20. An example is now described where the overcharge determination value X-Σ (for example, the overcharge determination value X-b1 shown in FIG. 3) is set by the microcomputer 14. The present invention is, however, by no means limited in this respect, and it is also possible, for example, for the microcomputer 25 to set the overcharge determination value X-Σ.

In this event, the microcomputer 25 can output an overcharge control signal (charging stop signal) by comparing an overcharge determination value (X-Σ) determined based on detection state information Cc of the battery state detection unit 28 with a cell voltage detected by the cell voltage detection circuit 24. The overcharge control signal is outputted to the microcomputer 14 of the charging device 1 via the port 20c.

At the battery pack 20, a shunt resistor is inserted into a charge path within the battery pack 20. A charge current detection circuit that detects the charge current is then installed. Charge current detection information is then inputted to the memory 27 of the microcomputer 25 and can be utilized as battery state information.

### Second Embodiment

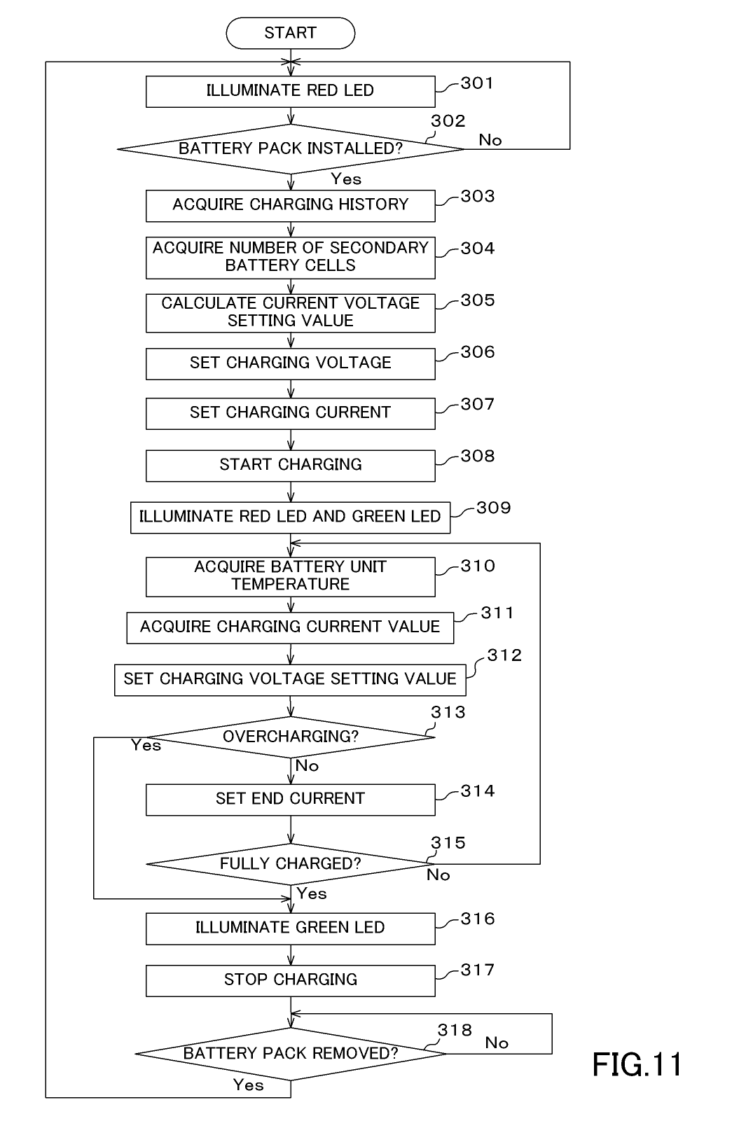

Next, a description is given with reference to FIGS. 11 to 18 of a second embodiment of the present invention. The same numbers are used for parts of the configuration that at the same as for the first embodiment and description thereof is omitted.

The charging system of the second embodiment has substantially the same configuration as for the first embodiment but differs from the first embodiment in that charging voltage is determined based on the states of the secondary battery cells 21a to 21d. The following is a description of the operation of the charging system of this embodiment.

When the charging device 1 is connected to the mains a.c. power supply 2, the microcomputer 14 of the charging device 1 first puts each part in an operable state and the microcomputer 14 is initialized. At the battery pack 20, the microcomputer 25 initially puts each part in an operable state. The microcomputer 14 then sequentially executes the processing shown in FIG. 11.

First, in step 301, the microcomputer 14 sets the red LED of the display circuit 8 on and indicates that it is before the start of charging.

Next, in step 302, the microcomputer 14 determines whether or not the battery pack 20 is installed in the charging device 1. In this embodiment, when the battery pack 20 is installed in the charging device 1, the microcomputer 25 of the battery pack 20 is energized. The microcomputer 25 then notifies the microcomputer 14 of information to the effect that the battery pack 20 is installed via the port 20c. When the microcomputer 14 is notified by the microcomputer 25 of this information, the microcomputer 14 determines that the battery pack 20 is installed in the charging device 1. The method of determining whether or not the battery pack 20 is installed described above is given merely as an example and is by no means limiting.

Next, in step 303, the microcomputer 14 acquires charging history information (battery state information) for up until now for the battery pack 20 from the microcomputer 25 of the battery pack 20. History information (battery state signal Cc) for each charging of the secondary battery cells 21a to 21d is stored in the memory 27 built into the microcomputer 25 of the battery pack 20. For example, history such as a number of times of the battery pack 20 has been charged at a high temperature greater than or equal to a prescribed battery temperature, a number of times of charging at a low temperature smaller than or equal to a prescribed battery temperature, and a total number of times of charging can be stored as charging history for the battery pack 20.

Next, in step 304, the microcomputer 14 acquires information relating to the number of cells for the secondary battery cells 21a to 21d built into the battery pack 20 from the microcomputer 25 of the battery pack 20.

Next, in step 305, the microcomputer 14 calculates a charging voltage setting value for the battery unit 21 based on information acquired from the microcomputer 25 of the battery pack 20 in step 303 and step 304.

The following is a description with reference to FIGS. 12 to 15 of a method for calculating charging voltage setting values. The microcomputer 14 first determines the level of frequency at which the battery pack 20 is charged at a high temperature. The level is determined as any of a high-level, a medium level, and a low-level. The determination is made based on the information acquired from the microcomputer 25 of the battery pack 20. As can be understood with reference to FIG. 12, the microcomputer 14 determines that, for example, a frequency of charging at a high temperature is a high-level when greater than or equal to a first prescribed number of times n1, is a medium level when greater than a second prescribed number of times n2 smaller than the first prescribed number of times n1 and less than the first prescribed number of times n1, and a low-level when less than the second prescribed number of times n2. The three classifications for the level are determined empirically from the point of view of the charging lifespan of the secondary battery cells 21a to 21d and are stored in the memory of the microcomputer 14.

A coefficient K (V/number of cells) corresponding to level classifications and a reference set value Y (V/number of cells) taken as a charging voltage setting value are stored in the memory of the microcomputer 14. As can be understood by referring to FIG. 12, when the frequency of charging at a high temperature is determined to be a high-level, the microcomputer 14 determines upon a value that is smaller than the reference set value Y (for example, 4.25 V/number of cells) by just a prescribed value b1 (for example, 0.02 V/cell), i.e. determines upon a value Y-b1 (V/number of cells) as a charging voltage setting value (Y-K).

When the frequency of the high-temperature charging is determined to be a medium level, the microcomputer 14 sets a value that is smaller than the reference set value Y by just a prescribed value a1 (b1>a1) (for example, 0.01V/cell), i.e. Y-a1 (V/number of cells) as the overcharge determination value (Y-K).

The microcomputer 14 sets the reference set value Y to the overcharge determination value (Y-K) when the frequency of the high-temperature charging is determined to be a low level.

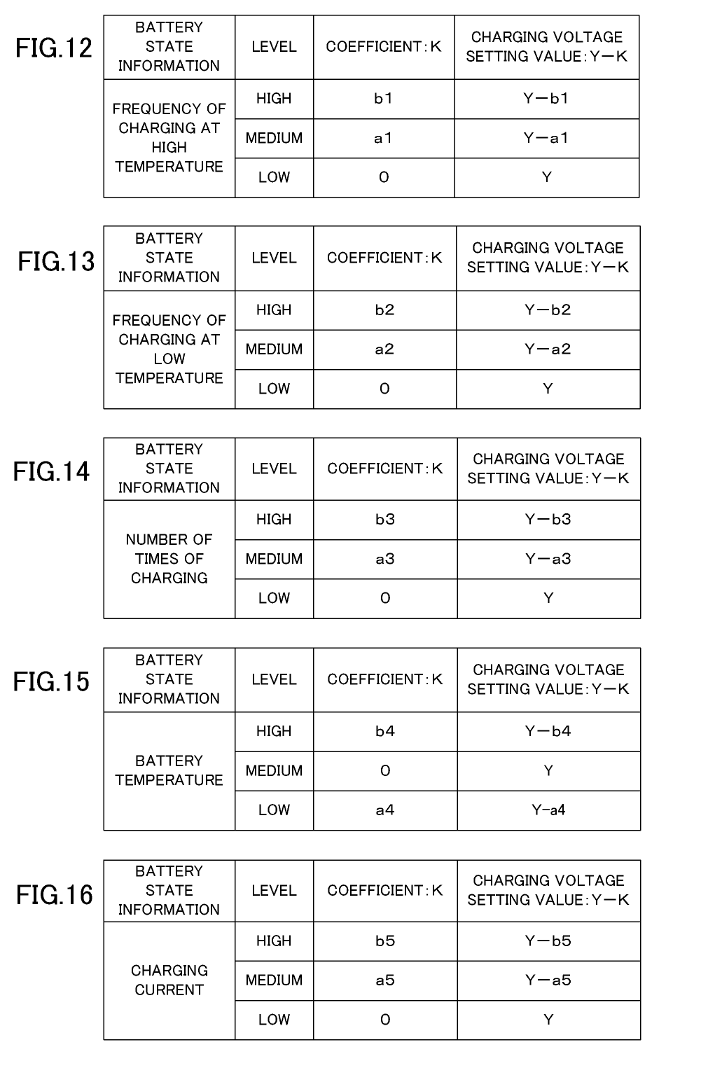

Similarly, the microcomputer 14 determines the level of frequency at which the battery pack 20 is charged at a high temperature. The level is determined as any of a high-level, a medium level, and a low-level. The determination is made based on the information acquired from the microcomputer 25. As can be understood with reference to FIG. 13, the microcomputer 14 determines that the frequency of low temperature charging is a high-level when the frequency of charging the battery pack 20 at a low temperature is a first prescribed number of times r1 or more, and determines upon a value that is smaller than the reference set value Y (V/number of cells) by just a prescribed value b2, i.e. a value Y-b2 (V/number of cells) as the charging voltage setting value (Y-K). When the frequency of charging at low temperature is greater or equal to than a second prescribed number of times r2 that is smaller than the first prescribed number of times r1 but is less than the first prescribed number of times r1, the microcomputer 14 determines that the frequency of low temperature charging is a medium level, and determines upon a value that is smaller than the reference set value Y by just a2 (b2>a2), i.e. determines upon a value Y-a2 (V/number of cells) as the charging voltage setting value (Y-K). The microcomputer 14 sets the reference set value Y to be the charging voltage setting value (Y-K) when the frequency of low temperature charging is determined to be a low-level that is less than the second prescribed a number of times r2.

Similarly, the microcomputer 14 determines the level of the number of times the battery pack 20 is charged acquired from the microcomputer 25. As can be understood with reference to FIG. 14, when it is determined that the total number of times of charging of the battery pack 20 is greater than a prescribed number of times, the microcomputer 14 determines upon a value that is smaller than the reference set value Y by just a prescribed value b3, i.e. determines upon a value Y-b3 (V/the number of cells) as the charging voltage setting value (Y-K). When the total number of charges is determined to be substantially the same as a prescribed value, the microcomputer 14 determines upon a value that is smaller than the reference set value Y by just a prescribed value a3 (b3>a3), i.e. determines upon a value Y-a3 (V/number of cells) as the charging voltage setting value (Y-K). When the total number of times of charging is determined to be less than a prescribed value, the microcomputer 14 sets the reference set value Y as the charging voltage setting value (Y-K).

Next, in step 306, the microcomputer 14 determines upon charging voltages according to the number of secondary battery cells 21a to 21d and notifies the voltage/current setting circuit 13 of the results. Specifically, the microcomputer 14 calculates a charging voltage Vc by multiplying the smallest value of the charging voltage setting value (Y-K) obtained from the frequency of charging at high-temperature, the frequency of charging at low temperature, and the total number of charges and the number of secondary battery cells 21a to 21d, and notifies the voltage/current setting circuit 13 of information relating to this charging voltage Vc. This charging voltage Vc is shown in FIG. 18.

Next, in step 307, the microcomputer 14 sets the charging current according to the temperature of the battery unit 21. The temperature of the battery unit 21 is then detected by the battery temperature detection circuit 23 via the thermosensitive unit 22 and can be outputted to the microcomputer 25. The microcomputer 14 then acquires the temperature of the battery unit 21 from the microcomputer 25. When the temperature of the battery pack 20 is within a normal temperature range (within a range of prescribed value T1 to T2) (T1<T2), the voltage/current setting circuit 13 is notified of a setting value for setting the charging current to I1.

When the temperature of the battery unit 21 is a low-temperature lower than the lower limit T1 for a normal temperature, the microcomputer 14 notifies the voltage/current setting circuit 13 of a setting value for setting the charging current to I3 (I3<I1). When the battery temperature is a high temperature higher than an upper limit value (T2) for the normal temperature, the microcomputer 14 notifies the voltage/current setting circuit 13 of a setting values for setting the charging current to I2 (I3<I2<I1).

Next, in step 308, the microcomputer 14 outputs a charge start signal for starting charging to the switching control circuit 6. The switching circuit 5 therefore starts to operate and charging of the battery pack 20 commences.

Next, in step 309, at the same time as the start of charging, the microcomputer 14 lights up the red LED and the green LED of the display circuit 8. It can therefore be displayed that the battery pack 20 is being charged.

Next, in step 310, the microcomputer 14 instructs detection of the temperature of the battery unit 21 to the microcomputer 25. The microcomputer 14 is therefore notified of temperature information of the battery unit 21 that is being monitored via the battery temperature detection circuit 23 etc. by the microcomputer 25.

Next, in step 311, the microcomputer 14 acquires information relating to the charging current values for the battery unit 21 via the charging current detection circuit 11.

Next, in step 312, the microcomputer 14 determines a value for the charging voltage Vc based on the temperature of the battery unit 21 and the charging current values are acquired in step 310 and step 311.

The following is a description with reference to FIGS. 15 and 16 an overcharge determination value in step 312. The microcomputer 14 first determines the level of the detected temperature for the battery unit 21. As can be understood by referring to FIG. 15, three types exist for this level, high, medium, and low. The microcomputer 14 then, for example, determines a high-level when the temperature of the battery unit 21 is greater than or equal to a certain first prescribed value t1, determines a medium level when the temperature is greater than or equal to a second temperature t2 that is lower than the first prescribed a temperature t1 and is less than the first prescribed temperature t1, and determines a low-level when the temperature is less than the second temperature t2.

As can be understood with reference to FIG. 15, next, when it is determined that the temperature level of the battery unit 21 is a high-level, the microcomputer 14 determines upon a value that is smaller than the reference set value Y by just a prescribed value b4, i.e. determines upon a value Y-b4 (V/number of cells) as the charging voltage setting value Y-K (V/number of cells). When the temperature level of the battery unit 21 is determined to be a low-level, the microcomputer 14 determines upon a value that is smaller than the reference set value Y by just a prescribed value a4 (b4>a4), i.e. a value Y-a4 (V/number of cells) as the charging voltage setting value Y-K (V/number of cells). When it is determined that the temperature level of the battery unit 21 is a medium level, the microcomputer 14 determines upon the reference set value Y as the charging voltage setting value Y-K (V/number of cells).

Similarly, as can be understood with reference to FIG. 16, the microcomputer 14 determines the level of the acquired charging current value. The level is determined as any of a high-level, a medium level, and a low level. As can be understood by referring to FIG. 16, when the level of the charging current value is determined to be a high-level, the microcomputer 14 determines upon a value that is smaller than the reference set value Y by just a prescribed value b5, i.e. a value Y-b5 (V/number of cells) as the charging voltage setting value Y-K (V/number of cells). When the level of the charging current value is determined to be a medium level, the microcomputer 14 determines upon a value that is smaller than the reference set value Y by just a prescribed value a5 (b5>a5), i.e. determines upon a value Y-a5 (V/number of cells) as the charging voltage setting value Y-K (V/number of cells). When the level of the charging current value is determined to be a low-level, the microcomputer 14 determines upon the reference set value Y as the charging voltage setting value Y-K (V/number of cells).

The microcomputer 14 then calculates a charging voltage Vc by multiplying the smallest of the charging voltage setting values (Y-K) obtained based on the battery temperature and the charging current and the number of secondary battery cells 21a to 21d and notifies the voltage/current setting circuit 13 of information relating to the charging voltage Vc.

Next, in step 313, the microcomputer 14 determines whether or not the voltages of the secondary battery cells 21a to 21d of the battery unit 21 detected by the charging voltage detection circuit 10 of the charging device 1 and the cell voltage detection circuit 24 of the battery pack 20 are greater than or equal to a preset overcharge determination value. When the voltage of any of the secondary battery cells 21a to 21d is greater than or equal to the overcharge determination value, the determination of step 313 is affirmative, and the microcomputer 14 proceeds to step 316. On the other hand, when the voltage of any of the secondary battery cells 21a to 21d is less than or equal to the overcharge determination value, the microcomputer 14 determines that the battery pack 20 is not being overcharged and step 314 is proceeded to.

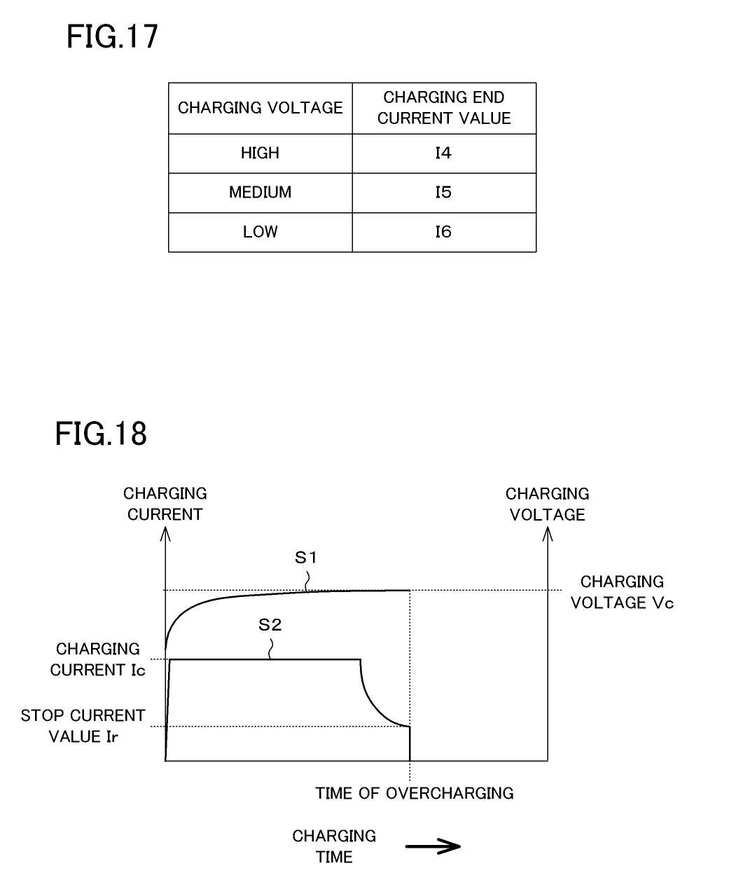

Next, in step 314, the microcomputer 14 sets a cut-off current value Ir (refer to FIG. 18) for determining whether or not there is full charging. As can be understood by referring to FIG. 17, for example, when the charging voltage Vc is a certain first prescribed value Vc4 or more, the microcomputer 14 sets a value for the cut-off current Ir in order to determine whether or not there is full charging. When it is determined that the charging voltage Vc is greater than or equal to a second prescribed value Vc6 (Vc4>Vc6) that is smaller than the first prescribed value Vc4 and is less than the first prescribed value Vc4, the microcomputer 14 sets a prescribed value for the stop current Ir for determining whether or not there is full charging to I5 (I4>I5). When the charging voltage setting value Vc is less than the second prescribed value Vc6, the microcomputer 14 sets a prescribed value for the cut-off current Ir for determining whether or not there is full charging to I6 (I4>I5>I6).

Typically, the amount of electrical power stored in the secondary battery cells becomes smaller as the charging voltage Vc becomes smaller. The amount of electrical power stored in the secondary battery cells also increases as the value for the stop current Ir for determining whether or not for charging is present is made smaller and the charging time is extended. As can be understood with reference to FIG. 18, it is possible to ensure that a large quantity of electrical power can be safely stored in the secondary battery cells by setting the value for the stop current Ir for determining whether or not full charging is present to be smaller for smaller values for the charging voltage setting value Vc.

Next, in step 315, the microcomputer 14 determines whether or not the battery unit 21 of the battery pack 20 is fully charged. It is possible to adopt a method of determination typically carried out for lithium ion secondary batteries for determining the presence or absence of full charging. For example, when charging is carried out using a constant current/fixed voltage charging method, first, charging is carried out while maintaining a constant charging current. When respective prescribed voltages are then reached at the secondary battery cells 21a to 21d of the battery pack 20, charging is carried out while maintaining a fixed charging voltage. When the respective secondary battery cells 21a to 21d then become fully charged, the charging current is lowered to the cut-off charging current value. It is then possible to determine whether or not there is full charging at each of the secondary battery cells 21a to 21d of the battery unit 21 by determining whether or not the value of the charging current has become the same as the stop charging current value set in step 314.

When the determination of step 315 is indeterminate, the microcomputer 14 returns to step 310. The processing of step 310 to step 315 is then executed until the determination of step 315 onwards is affirmative. On the other hand, when the determination of step 315 is affirmative, the microcomputer 14 proceeds to the next step 316.

In the next step 316, the microcomputer 14 gives notification that charging is complete by causing a green light to light up at the display circuit 8.

Next, in step 317, the microcomputer 14 controls the operation of the switching circuit 5 so as to stop charging by outputting a charging stop signal to the switching control circuit 6.

Next, in step 318, the microcomputer 14 determines whether or not the battery pack 20 has been removed from the charging device 1. When the battery pack 20 has been removed, the determination here is affirmative and step 301 is returned to. The microcomputer 14 then repeatedly executes the processing from step 301 to step 318.

As shown in the above description, in this embodiment, the charging voltage is set taking into consideration the states of the secondary battery cells of the battery pack during charging. Charging of the secondary battery cells can also be carried out using charging voltages set taking into consideration the states of the secondary battery cells. It is therefore possible to accurately set an optimum charging voltage that fluctuates due to the number of times of use of the battery packs and the temperature etc. It is then possible to effectively execute charging of the battery packs in a safe manner.

In the above, a description is given of the embodiments of the present invention but the present invention is by no means limited to the above embodiments.

For example, in each of the above embodiments, a description is given of the case where the battery pack 20 has four secondary battery cells but it is also possible for the battery pack 20 to have more than four battery cells or to have a single battery cell.

Various practical examples and modifications are possible to the present invention without deviating from broad spirit and scope of the present invention. The above embodiments are also provided merely to describe the present invention and by no means limit the scope of the present invention. This is to say that the scope of the present invention is as laid out in the patent claims rather than as laid out in the embodiments. Various modifications implemented within the scope of the patent claims and within the range of the intended equivalent invention can be considered within the scope of the present invention.

This application is based on Japanese Patent Application No. 2008-174360 and Japanese Patent Application No. 2008-174409. The specifications, scope of the patent claims, and drawings of Japanese Patent Application No. 2008-174360 and Japanese Patent Application No. 2008-174409 are hereby incorporated in their entirety in this specification.

### INDUSTRIAL APPLICABILITY

The charging system and the battery pack of the present invention can be applied to secondary battery cells.

1. A charging system comprising:
a battery pack having at least one secondary battery cell;
a voltage detection unit that detects voltages of the at least one secondary battery cell;
a determination value determining unit that determines an overcharge determination value for determining whether or not a charging state of a secondary battery cell is a state of being overcharged;
a determining unit that determines that a secondary battery cell is being overcharged when a voltage of the secondary battery cell is the overcharge determination value or more; and
a control unit that stops charging of the battery pack when it is determined that the secondary battery cell is being overcharged,
characterized in that the determination value determining unit determines the overcharge determination value in accordance with a state of the secondary battery cell.

2. The charging system according to claim 1,
characterized in that the determination value determining unit determines the overcharge determination value based on the number of times of charging of the at least one secondary battery cell.

3. The charging system according to claim 2,
characterized in that the overcharge determination value is set to be smaller than for the case when the number of times of charging is less than the prescribed number of times, when the number of times of charging is greater than the prescribed number of times.

4. The charging system according to claim 1,
characterized in that the determination value determining unit determines the overcharge determination value based on a number of times of charging at a high temperature when the at least one secondary battery cell is at a prescribed temperature or more during charging.

5. The charging system according to claim 4,
characterized in that the overcharge determination value is set to be smaller than the case when the number of times of charging at high temperature is less than or equal to a prescribed number of times, when the number of times of charging at a high temperature is greater than a prescribed number of times.

6. The charging system according to claim 1,
characterized in that the determination value determining unit determines the overcharge determination value based on the number of times of charging at low temperature when the at least one secondary battery cell is at a prescribed temperature or less during charging.

7. The charging system according to claim 6,
characterized in that the overcharge determination value is set to be smaller than the case when the number of times of charging at low temperature is less than or equal to a prescribed number of times, when the number of times of charging at a low temperature is greater than the prescribed number of times.

8. The charging system according to claim 1,
characterized in that the determination value determining unit determines the overcharge determination value based on the number of the at least one secondary battery cell.

9. The charging system according to claim 8,
characterized in that the overcharge determination value is set to be smaller than the case when the number of the at least one secondary battery cell is the prescribed number or less, when the number of the at least one secondary battery cell is greater than a prescribed number.

10. The charging system according to claim 1,
further comprising a temperature detection unit that detects the temperature of the at least one secondary battery cell during charging,
characterized in that the determination value determining unit determines the overcharge determination value based on temperatures detected by the temperature detection unit.

11. The charging system according to claim 10,
characterized in that the overcharge determination value is set to be smaller than when the detected temperature is within the prescribed range, when the detected temperature is outside a preset prescribed range.

12. The charging system according to claim 1,
further comprising a charging current detection unit that detects charging current of the at least one secondary battery cell during charging,
characterized in that the determination value determining unit determines the overcharge determination value based on charging current value detected by the charging current detection unit.

13. The charging system according to claim 12,
characterized in that the overcharge determination value is set to be smaller than when the value of the detected charge current is the prescribed value or less, when the value of the detected charge current is larger than the prescribed value.

14. The charging system according to claim 1,
further comprising a storage unit that stores the number of times of charging, the number of times of charging at high temperature, and the number of times of charging at low temperature,
characterized in that the determination value determining unit determines the overcharge determination value based on the number of times of charging, the number of times of charging at high temperature, and the number of times of charging at low temperature stored in the storage unit.

15. The charging system according to claim 1,
characterized in that the determination value determining unit is provided at the battery pack.

16. The charging system according to claim 1,
characterized in that the voltage detection unit detects a voltage of each secondary battery cell, and
the determining unit determines for each secondary battery cell whether or not a charging state of the secondary battery cell is in a state of being overcharged.

17. The charging system according to claim 1,
characterized in that the overcharge determination value is determined based on a secondary battery cell whose temperature rise is largest of the at least one secondary battery cell.

18. The charging system according to claim 1,
characterized in that the overcharge determination value is determined in such a manner that a smallest value is set for a secondary battery cell whose temperature rise is largest of the at least one secondary battery cell.

19. The charging system according to claim 1,
characterized in that the at least one secondary battery cell is a lithium ion battery cell.

20. The charging system according to claim 1,
further comprising a charging voltage determining unit, that determines charging voltage of the at least one secondary battery cell in accordance with the state of the at least one secondary battery cell.

21. The charging system according to claim 20,
characterized in that the charging voltage determining unit determines the charging voltage based on the number of times of charging of the at least one secondary battery cell.

22. The charging system according to claim 20,
characterized in that the charging voltage determining unit determines the charging voltage based on the number of times of charging at a high temperature when the at least one secondary battery cell is at a prescribed temperature or more during charging.

23. The charging system according to claim 20,
characterized in that the charging voltage determining unit determines the charging voltage based on the number of times of charging at a low temperature when the at least one secondary battery cell is at a prescribed temperature or less during charging.

24. The charging system according to claim 20,
characterized in that the charging voltage determining unit determines the charging voltage based on the temperature of the at least one secondary battery cell.

25. The charging system according to claim 20,
characterized in that the charging voltage determining unit determines the charging voltage based on the charging current of the at least one secondary battery cell.

26. The charging system according to claim 20,
further comprising a cut-off current determining unit,that determines a cut-off current value used to determine whether or not the at least one secondary battery cell is fully charged based on the charging voltage determined by the charging voltage determining unit.

27. A battery pack comprising:
a plurality of secondary battery cells; and
a storage unit that stores charging history and charging states for the at least one secondary battery cell in a correlated manner.
